(19) United States
(12) Patent Application Publication
(10) Pub. No.: US 2008/0166230 A1
(43) Pub. Date: Jul. 10, 2008

(54) Fan Frame Having Embedded Power Source Contact Terminals And Method For Manufacturing The Same

(76) Inventor: Richard Lee, Taipei (TW)

Correspondence Address: HDSL, 4331 STEVENS BATTLE LANE, FAIRFAX, VA, 22033, US

(21) Appl. No.: 11/621,110

(22) Filed: Jan. 8, 2007

(51) Int. Cl. F04D 29/60; B29C 45/17

(52) U.S. Cl. 415/213.1; 264/328.2

(57) ABSTRACT

A fan frame has embedded power source contact terminals. The fan frame includes a fan frame and a pair of contact terminals for connecting to a power source. When the fan frame is made by means of plastic injection molding, the pair of contact terminals is formed in the fan frame by means of coating injection, and only the contact portions of the pair of contact terminals are exposed for the conductive contact.

### BACKGROUND OF THE INVENTION

1. Field of the Invention

The present invention relates to a fan, and in particular to a heat-dissipating fan applicable to an electronic product and the method for manufacturing the same.

2. Description of Prior Art

With regard to the existing compact electronic products, such as PDA or mobile phone, they are designed to be convenient to carry. As a result, the internal space thereof is small. If a fan is to be additionally provided therein to facilitate the heat-dissipating operation, the fan frame of the existing fan will impede the installation thereof. Especially, with regard to a plug connecting to a power source, an electric line is used to connect with the plug and the circuit board of the fan. Therefore, when such structure is to be installed in a small space, it will inevitably occupy too much space.

Moreover, the fan also plays an important role on a common personal computer or notebook computer. Since the heat dissipation is a critical problem in the operation of a computer, the failure of the fan may easily lower the operation efficiency of the computer or even stop the operation. However, the installation and detachment of the traditional fan of the computer is not convenient due to its structure, so that it is not easy for the user to replace with a new one by himself. Further, since the installation and detachment are not easy, it is inconvenient for the user to perform periodical cleaning. As a result, dirt may be adhered onto the fan to affect the magnitude of the generated wind. According to the above, the existing fan indeed has some drawbacks and problems.

In view of the above, the inventor proposes the present invention to overcome the above problems based on his expert experiences and deliberate researches.

### SUMMARY OF THE INVENTION

The present invention is to provide a fan frame having embedded power source contact terminals and the method for manufacturing the same, by which the fan and the contact terminals connected to the power source can be directly disposed on the fan frame without any electric lines, thereby to reduce the installation space occupied by the fan and facilitate the installation and detachment thereof

The present invention provides a fan frame having embedded power source contact terminals, which comprises a fan frame and a pair of contact terminals for connecting to a power source. The pair of the contact terminals is embedded into the fan frame. Each contact terminal has a contact portion, and each contact portion is exposed to the outside of the fan frame.

In order to achieve the above objects, the present invention provides a method for manufacturing a fan frame having embedded power source contact terminals. When a fan frame is made by means of plastic injection molding, two contact terminals for connecting to the power source are formed in the fan frame by means of coating injection. Only the contact portions of the pair of contact terminals are exposed for conductive contact.

### BRIEF DESCRIPTION OF THE DRAWINGS

FIG. 1 is an exploded schematic view of the first embodiment of the present invention and a circuit board;

FIG. 2 is an assembled schematic view of the first embodiment of the present invention and a circuit board;

FIG. 3 is an exploded schematic view of the second embodiment of the present invention and a circuit board;

FIG. 4 is an assembled schematic view of the second embodiment of the present invention and a circuit board;

FIG. 5 is an exploded schematic view of the third embodiment of the present invention and a circuit board;

FIG. 6 is an assembled schematic view of the third embodiment of the present invention and a circuit board;

FIG. 7 is an exploded schematic view of the fourth embodiment of the present invention and a circuit board; and

FIG. 8 is an assembled schematic view of the fourth embodiment of the present invention and a circuit board.

### DETAILED DESCRIPTION OF THE INVENTION

In order to make the Examiner to better understand the characteristics and technical contents of the present invention, a detailed description relating thereto will be made with reference to the accompanying drawings. However, it should be understood that the drawings are illustrative but not used to limit the scope of the present invention.

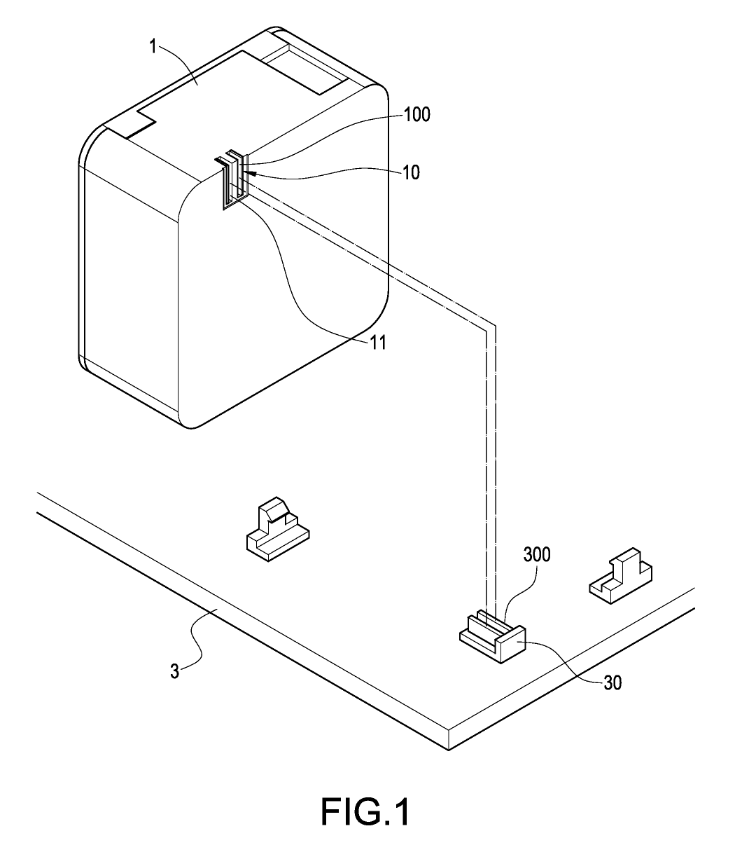

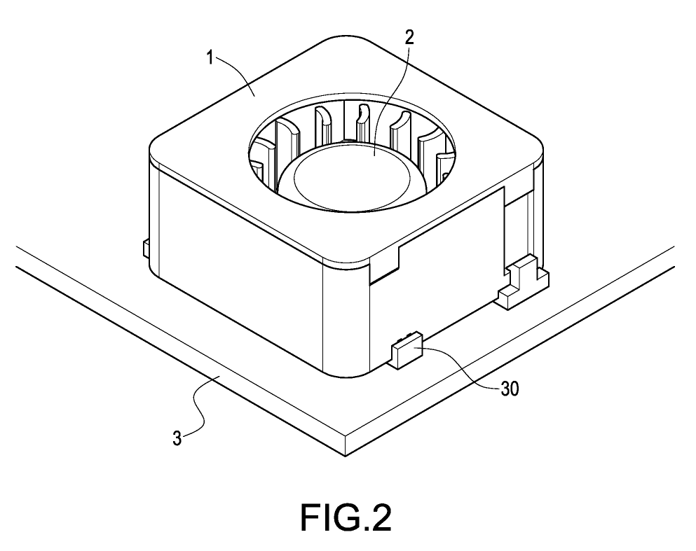

FIG. 1 is an exploded schematic view of the first embodiment of the present invention and a circuit board, and FIG. 2 is an assembled schematic view of the first embodiment of the present invention and a circuit board. The present invention provides a fan frame having embedded power source contact terminals and the method for manufacturing the same. A rotor 2, stator and circuit board (not shown) of the fan are disposed in the fan frame 1. With the fan frame 1, these components can be assembled together on a motherboard 3 within the electronic product.

According to the above, in the present invention, when the fan frame 1 is made by means of plastic injection molding, two contact terminals 10 for connecting to a power source are formed in the fan frame 1 by means of coating injection. Only the contact portions 100 of the pair of contact terminals 10 are exposed to bring into conductive contact with a corresponding conductive seat 30 on the motherboard 3. The contact terminals 10 coated in the fan frame 1 are electrically connected with the circuit board in the fan frame 1, thereby to provide the stator of the fan with necessary electricity. In the first embodiment of the present invention, the contact terminal 10 is a male insert pin and located at a corner of one side of the fan frame 1. The corner is provided with insertion slots 11 for exposing the contact portions 100 of the contact terminals 10. The insertion slot 11 exactly mates with the piece-like conductive terminal 300 of the conductive seat 30, so that the conductive terminals 300 can be inserted into the insertion slots 11 to contact with the contact portions 100 of the contact terminals 10.

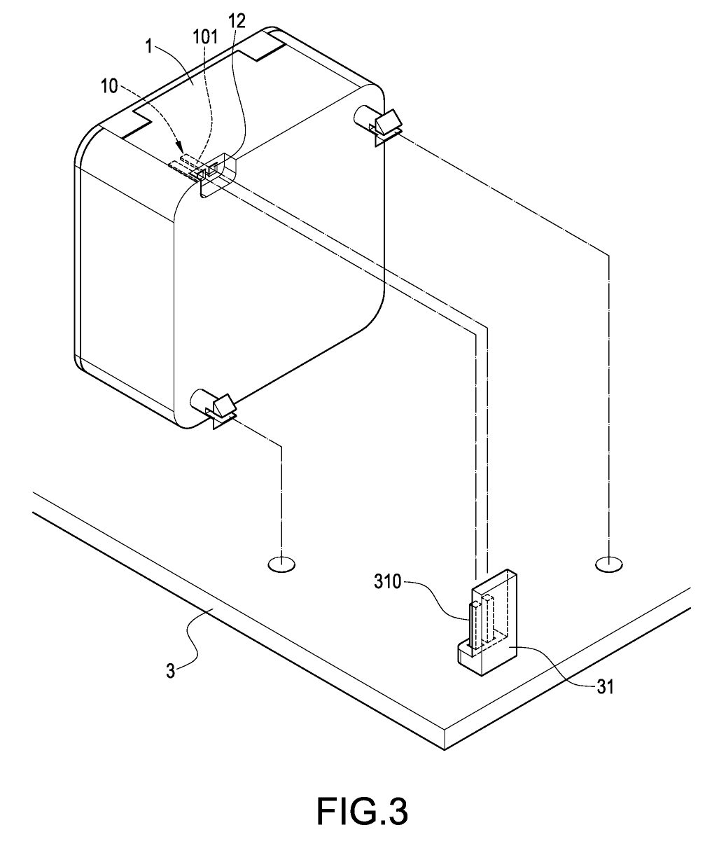

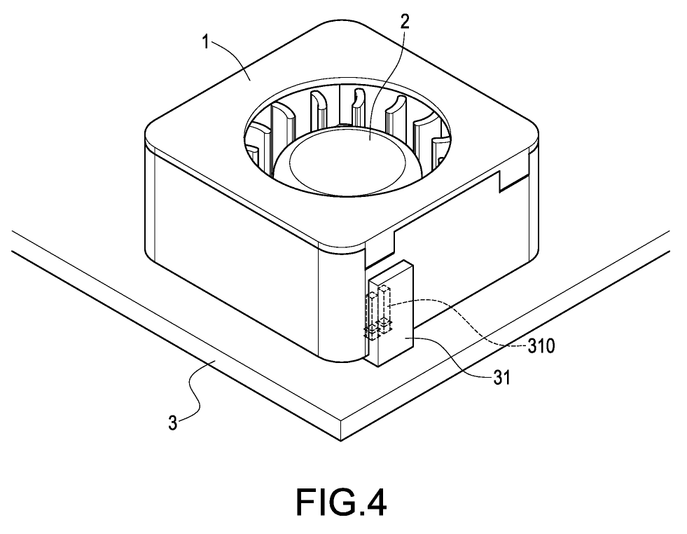

Further, FIG. 3 is an exploded schematic view of the second embodiment of the present invention and a circuit board, and FIG. 4 is an assembled schematic view of the second embodiment of the present invention and a circuit board. The contact terminal 10 can be a female insert pin and similarly located at a corner of one side of the fan frame 1. The corner is provided with insertion holes 12. The inner wall of the insertion holes 12 is used for exposing the contact portion 101 of the contact terminal 10, so that the needle-like conductive terminals 310 of the conductive seat 31 can be inserted therein. In this way, electricity conduction can be generated by means of the contact therebetween.

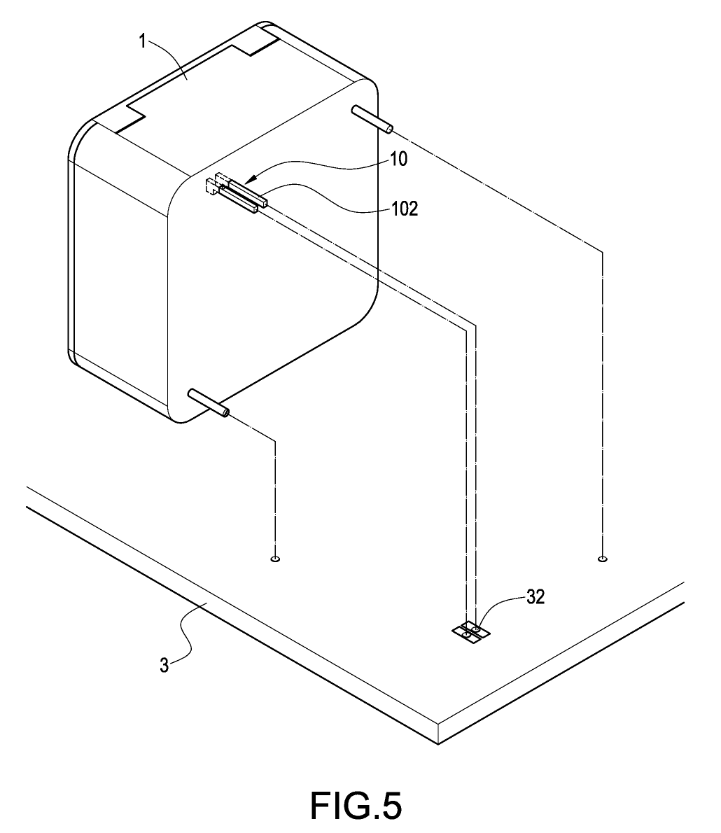

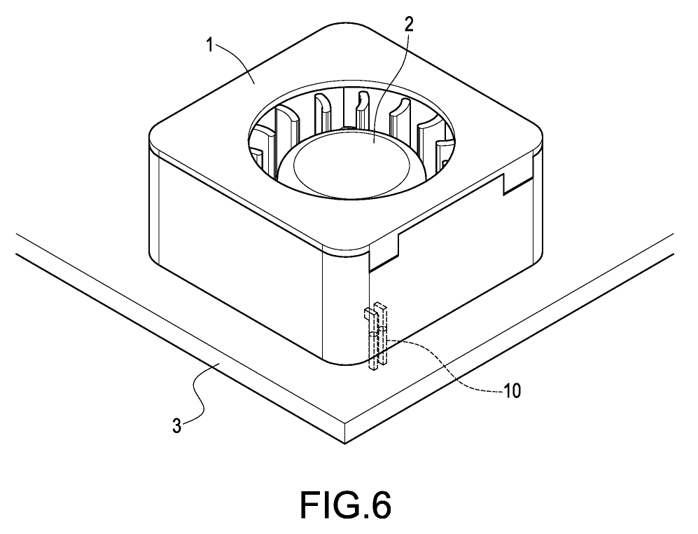

Further, FIG. 5 is an exploded schematic view of the third embodiment of the present invention and a circuit board, and FIG. 6 is an assembled schematic view of the third embodiment of the present invention and a circuit board. The contact terminal 10 can be an insert clip. The contact portion 102 thereof is formed into a needle and extends from the fan frame 1 so as to be directly inserted into the preset penetrating hole 32 of the conductive circuit (not shown) of the motherboard 3.

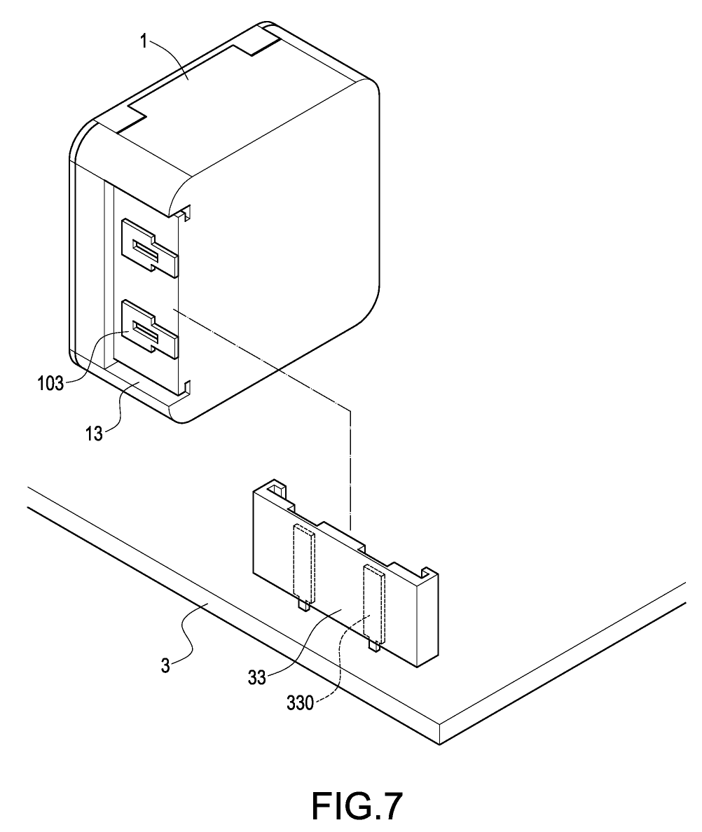

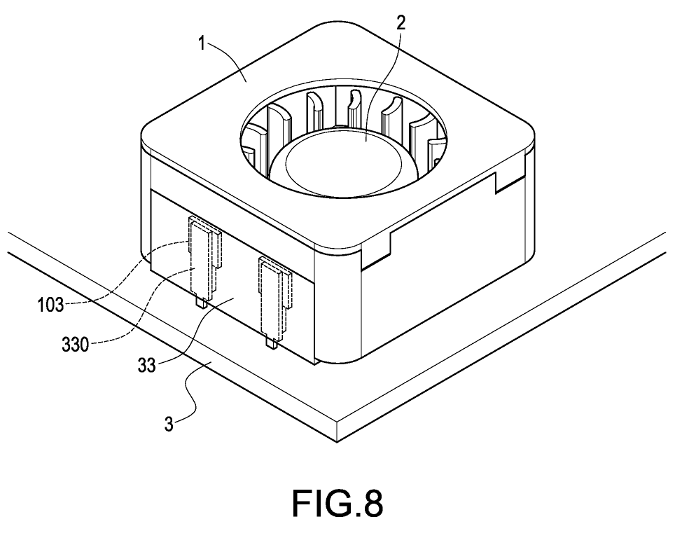

Finally, FIG. 7 is an exploded schematic view of the fourth embodiment of the present invention and a circuit board, and FIG. 8 is an assembled schematic view of the fourth embodiment of the present invention and a circuit board. The contact terminal 10 can be a contact clip. The contact portion 103 thereof is formed into a piece and adhered onto a trough 13 formed by recessing inwardly from one side of the fan frame 1. The trough 13 exactly mates with the conductive seat 33 so as to contact with the conductive terminals 330 of the conductive seat 33.

Therefore, according to the present invention, the contact terminals for connecting the fan with the power source can be directly disposed on the fan frame without any electric lines, thereby to reduce the installation space occupied by the fan and facilitate the installation and detachment thereof

According to the above, the present invention indeed achieves the desired objects and overcomes the drawbacks of prior art. Further, it has novelty and inventive steps and thus conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A fan frame having embedded power source contact terminals, comprising:
a fan frame; and
a pair of contact terminals for connecting to a power source and embedded into the fan frame, each contact terminal having a contact portion, and each contact portion being exposed to the outside of the fan frame.

2. The fan frame having embedded power source contact terminals according to claim 1, wherein the pair of contact terminals is a male insert pin, and the fan frame is provided thereon with insertion slots for exposing the contact portions.

3. The fan frame having embedded power source contact terminals according to claim 1, wherein the pair of contact terminals is a female insert pin, the fan frame is provided thereon with insertion holes, and the contact portion is exposed onto the inner wall of the insertion hole.

4. The fan frame having embedded power source contact terminals according to claim 1, wherein the pair of contact terminals is an insertion clip, and the contact portion is formed into a needle and extends from the fan frame.

5. The fan frame having embedded power source contact terminals according to claim 1, wherein the pair of contact terminals is a contact clip, a trough is formed by recessing inwardly from one side of the fan frame, and the contact portion is formed into a piece and adhered onto the trough.

6. A method for manufacturing the fan frame having embedded power source contact terminals according to claim 1, wherein when a fan frame is made by means of plastic injection molding, two contact terminals for connecting to the power source are formed in the fan frame by means of coating injection, and only the contact portions of the pair of contact terminals are exposed for conductive contact.
